(19) United States
(12) Patent Application Publication
(10) Pub. No.: US 2009/0300671 A1
(43) Pub. Date: Dec. 3, 2009

(54) Controlling Access to Multimedia Content

(75) Inventors: Charles Varnon Scott, Austin, TX (US); James Leonard Cansler, Cedar Park, TX (US); Ankur Mukerji, Auburn, CA (US); Scott Anthony White, Austin, TX (US)

Correspondence Address: AT&T Legal Department - JW;Attn: Patent Docketing, Room 2A-207, One AT&T Way, Bedminster, NJ, 07921, US

(73) Assignee: AT&T KNOWLEDGE VENTURES, L.P., Reno, NV (US)

(21) Appl. No.: 12/130,739

(22) Filed: May 30, 2008

(51) Int. Cl. H04N 7/16; H04L 9/32

(52) U.S. Cl. 725/27; 725/28; 725/30; 726/5

(57) ABSTRACT

A disclosed access control application and an associated method for managing access to multimedia content include enabling an administrator, e.g., a parent, to create a user account for a user, e.g., a child, and a password and a profile for the user account. The method further includes assigning an access level to the user and generating an initial set of content access indicator (CAIs) based on the access level. The initial CAI influences or determines the user's ability to access content associated with the access level. The method further includes modifying at least one of the CAIs in response to a request from the administrator. When a user subsequently send a navigation signal or command while the user account is active, the navigation signal is processed based at least in part on the CAIs to prevent the user from accessing content that the applicable CAI indicates as being restricted.

### BACKGROUND

1. Field of the Disclosure

The present disclosure relates to multimedia content and, more particularly, networks and systems for distributing multimedia content.

2. Description of the Related Art

In the field of television (TV) and other multimedia and entertainment applications, features exist to give parents or others with supervisory roles coarse control over content that children may listen to, watch, or both. The V-chip, for example, enables parents to use TV ratings as a rough proxy for determining acceptable and unacceptable content for children.

### BRIEF DESCRIPTION OF THE DRAWINGS

FIG. 1 is a block diagram of selected elements of an embodiment of a multimedia distribution network;

FIG. 2 is a block diagram of selected elements of an embodiment of a multimedia handling device;

FIG. 3 is a block diagram of selected elements of an application server in a multimedia content distribution network;

FIG. 4 depicts an embodiment of a content accessibility control database;

FIG. 5 is a flow diagram illustrating selected elements of an embodiment of a content accessibility control application;

FIG. 6 is a flow diagram illustrating selected elements of an embodiment of a method for modifying content access indicators;

FIG. 7 is a pictorial representation of an operational aspect of one embodiment of a content accessibility control application; and

FIG. 8 is a flow diagram of selected elements of an embodiment of a method for modifying content access indicators.

### DESCRIPTION OF THE EMBODIMENT(S)

A disclosed content accessibility control (CAC) application suitable for use within the context of a multimedia content platform enables an administrative end user to control a subordinate end user's access to content. In a familial context, the subordinate end user (subordinate) may be a family's child or children while the administrative end user (administrator) may be the family's parent(s), guardian(s), or other supervisor(s). The CAC application enables an administrator to create a user account for a subordinate and to tag or otherwise identify specific content deemed by the administrator to be acceptable for viewing, listening to, playing, or otherwise experiencing by the subordinate. When the subordinate wishes to experience content, the subordinate activates the subordinate's user account by logging into the account. When a subordinate's user account is active, the multimedia platform effectively filters the available content so that the subordinate has access to only that content approved by the administrator.

Existing techniques for controlling other's access to content, such as techniques based largely or entirely on TV program ratings, Motion Picture Association of America (MPAA) ratings, or the like, generally provide only a limited solution to the access control problem. Program ratings may provide only a rough approximation of the administrator's estimation of what content is acceptable for consumption by a subordinate. Parents, as an example, may have no objection to certain content that “exceeds” a predetermined ratings threshold, while they may simultaneously disapprove of certain content that complies with the predetermined ratings threshold. In this example, the ratings threshold is simultaneously both over-inclusive and under-inclusive of acceptable content.

The disclosed subject matter effectively implements end-user control over access to content via a multimedia handling device. In some embodiments, this control functionality allows end user administrators to define content restrictions at multiple levels of granularity. For example, in the context of a multimedia handling device, system, or network for providing television content and/or on-demand video content, the CAC application enables administrators to define access privileges for individual episodes of particular series, the entire series, all content offered on a particular channel, and so forth. The access privileges may be defined for individual subordinates or for a defined group of class of subordinates. In one implementation, parents (administrators) create user accounts and establish user profiles and logins for the user accounts. The administrators might then establish access levels, e.g. “Adult” or “Child.” The administrators might then define the content restriction for one or more of the defined access levels such that only designated shows should be presented to users having the applicable access level. In one embodiment, content restrictions are defined using content access indicators (CAIs).

Because of the relatively recent proliferation of multimedia content sources including expanded television services with hundreds of existing channels and resources to accommodate thousands of channels, video on demand (VOD) content, digital video recorder content, and so forth, some embodiments of the disclosed CAC application may facilitate an initial set up of CAIs. The application could provide, for example, a list of possible starter content mixes based on ages of the users with the option to adjust by adding or removing access to specific shows.

After CAIs have been defined, a CAC application will interact with a set top box or other media presentation device to restrict the accessible content to only content which is designated. Administrators may customize the CAIs individually or otherwise, by flagging programs as being accessible to or restricted from a class of users or one or individuals in the class.

Disclosed herein are multiple techniques for allowing administrators to tag shows, i.e., set or modify CAIs for a particular show for one or more users. The administrator may, for example, tag a program while watching the program itself Programs might also be tagged from any of various content listing interfaces including, as examples, a Digital video recorder (DVR) listing, an Electronic Programming Guide (EPG) listing, or a VOD guide.

In embodiments suitable for their flexibility, parents would be enabled to specify whether an individual show or an entire series is acceptable. They could similarly allow an entire channel. Parents could also restrict access to individual episodes from an otherwise acceptable program or permit access to an individual episode of an otherwise restricted program. After a parent or other administrator logs out of the TV or other type of media device, system, or network, a user might then log into the system. During the time the user's account is active, i.e., the user remains logged on, all navigation elements including content listing elements function in conjunction with the CAIs so that EPG interfaces, DVR interfaces, and VOD interfaces present listings for accessible content only. Similarly, navigation elements such as simple channel up/down buttons operate under the supervision of the CAC application such that a child user, for example, cannot access restricted content by “flipping” to a channel containing restricted access. If, for example, a child user is viewing Channel 9 during a time when adjacent Channel 10 is showing restricted content, the child user will skip from Channel 9 to Channel 11 if the child user hits the channel up button (assuming Channel 11's content is permitted or accessible to children). An alternative implementation desirable for its simplicity might support just two access levels, for example, “unrestricted” and “restricted” access levels. Parents could then choose settings to: 1) require password access to unrestricted content, and 2) show only approved shows to restricted audience. Parents might then define approved content for the restricted class of users.

The CAC application is applicable to a wide variety of media, including television (TV) programming, DVR, VOD, music, photos, news, clips, and so forth.

In one aspect, a disclosed CAC application and an associated method for managing access to multimedia content include enabling an administrator, e.g., a parent, to create a user account for a user, e.g., a child, and to create a password and a profile for the user account. The method may further include assigning an access level to the user and generating an initial set of CAIs based on the access level. The CAIs influence or determine the user's ability to access content associated with the indicator. The method may further include modifying at least one of the CAIs in response to a request from the administrator. When a user subsequently sends a navigation signal or command while the user account is active, the navigation signal is processed based at least in part on the CAIs to prevent the user from accessing content that the applicable CAI indicates as being restricted. For example, if the user asserts an up/down channel button on a remote control device, the application and method may determine if the content currently playing on a channel that is numerically adjacent to the current channel is restricted. If the content is restricted, the application and method may skip over the adjacent channel. Similarly, if a user asserts a button to display an EPG or other type of content listing, the application and method may filter that listing to list only that content to which the user has access privileges.

The user profile may indicate various characteristics of the user including, as examples, the user's age and gender. The user profile might also indicate one or more content categories, e.g., TV-Y7, or sub-categories, e.g., S(ex), L(anguage), V(iolence), or D (themes). The user profile information may be used to generate a content access level and an associated set of initial CAIs for the user. The use of a predetermined or automatically generated initial set of CAIs facilitates the rapid creation of CAIs for one or more classes of users, which may be beneficial in platforms supporting a large number of channels or other sources of content.

The modifying of the CAIs may include launching or otherwise invoking a CAI modification interface from any of various programming or listing interfaces including an EPG interface, a DVR interface, or a VOD interface. In addition, a CAI modification interface may be launched while the administrator is viewing content, sometimes referred to herein as “on-the-fly,” in response to a remote control or set top box input. Enabling the administrator to modify content restrictions for a user or class of users from a variety of interfaces beneficially extends the accessibility and flexibility of a CAC application.

The CAIs may, themselves, be flexible in their implementation. A CAI may, for example, influence or determine a user's ability to access a single content item, e.g., a single episode of a series or program or a single movie, an entire series of a program, or any content distributed via a particular channel. The CAIs may be configured or interpreted hierarchically to facilitate creation of relatively sophisticated access restriction profiles. For example, CAIs may define default access values for all content and then selectively define exceptions to default values, exceptions to selected exceptions, and so forth.

In another aspect, a disclosed software application or computer program product, referred to herein as a CAC application, includes instructions, stored on computer readable media, for managing access to multimedia content. The instructions include instructions to create a user account in response to a request from an administrator, associate a password and user profile with the user account, where the user profile indicates one or more characteristics of the user, and associate CAIs with the user. The CAIs are based, at least in part, on the user profile. When the user account is active, the software application permits or prohibits access to content items based on the CAIs. When an administrator account is active, the software application may enable an administrator or other privileged user to modify the user's CAIs. The CAIs may influence or determine the user's access privileges and/or access restrictions for an entire channel, a series or program, or a particular episode of a series or program. Modifying the CAIs could include, as examples, permitting access to a particular episode of a series that the user is otherwise restricted from accessing, restricting access to an episode of a series that the user is otherwise permitted to access, permitting access to a program on a channel that the user is otherwise restricted from accessing, prohibiting access to a program on a channel that the user is otherwise permitted to access, and so forth.

The CAC application may associate the CAIs with a user by assigning an access level to the user account based on the user profile and determining the CAIs based on the access level. For example, a standard set of CAIs may be predetermined for one or more user access levels and the preprogrammed CAIs may be retrieved from local or remote storage to create an initial or default set of CAIs for one or more users. The CAC application may also include instructions to respond to a user request to list available content by presenting a content listing interface that lists only that content to which the user has access. For example, a user may communicate to or with a set top box or other multimedia handling device to display an EPG on a television monitor or other type of display device. The CAC application may respond to the request by presenting an EPG display that lists content to which the user has access privileges while suppressing the listing of any content to which the user lacks access privileges. Similarly, the CAC application may modify or otherwise interact with a VOD interface, a DVR interface, or any other interface that lists content so that the applicable interface displays content that is accessible to the user without displaying content that is restricted to the user. Although the CAC application is described herein in conjunction with a set top box, the access control application is applicable to a wide variety of entertainment and media devices and platforms including game consoles, portable media devices, DVRs, set-top boxes, personal computers (PCs), and so forth.

In another aspect, a disclosed set top box or other type of multimedia handling device includes a processor for handling general purpose logic and functions and a multimedia resource for processing multimedia data. The multimedia resource might include, for example, a video decoder suitable for converting an encrypted and/or compressed stream of multimedia content to analog signals suitable for recreating the multimedia content via a display screen and/or audio speakers. In other embodiments, the multimedia resource might include an analog baseband or other resource suitable for demodulating audio signals transmitted via a cellular or other type of wireless communication network. The multimedia handling device may be implemented as a set top box, an MP3 or other type of audio player, or any of a variety of other devices possessing functionality to produce multimedia output suitable for visual or audible consumption by a user. The disclosed multimedia handling device may further include storage media, accessible to the processor, and computer executable instructions, embedded in the storage media, for a CAC application or a portion thereof The CAC application may include or facilitate the ability of an administrator to alter CAIs for one or more users “on the fly” or, in other words, while the administrator is viewing a program or other type of multimedia content. The administrator may transmit a request or command to invoke this feature, for example, by asserting a button on a remote control device while watching a particular program, movie, or other type of content. The application may detect and respond to the request or command by presenting a CAI modification interface to the administrator. The CAI modification interface may include one or more selectable objects for identifying one or more users and for modifying CAIs for the selected user(s) with respect to the applicable content. When one of the selected users subsequently logs on to the multimedia handling device, system, or network, the user's access privileges for the applicable content are determined by the modified or altered value of the CAI.

In the following description, details are set forth by way of example to facilitate discussion of the disclosed subject matter. It should be apparent to a person of ordinary skill in the field, however, that the disclosed embodiments are exemplary and not exhaustive of all possible embodiments. Throughout this disclosure, a hyphenated form of a reference numeral refers to a specific instance of an element and the un-hyphenated form of the reference numeral refers to the element generically or collectively. Thus, for example, widget 12-1 refers to an instance of a widget class, which may be referred to collectively as widgets 12 and any one of which may be referred to generically as a widget 12.

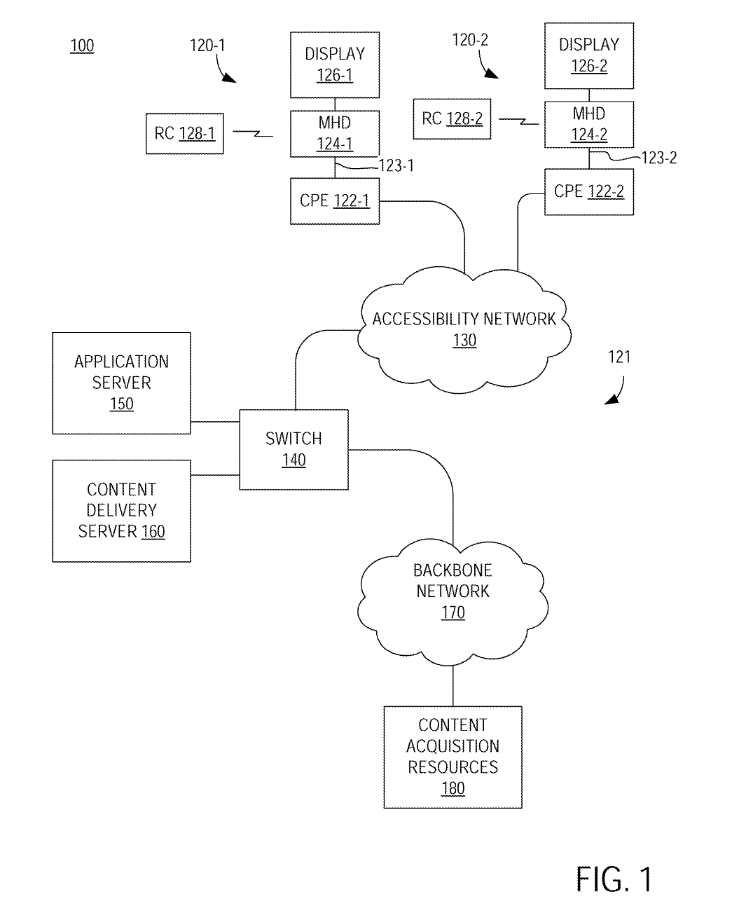

Turning now to the drawings, FIG. 1 is a block diagram illustrating selected elements of an embodiment of a multimedia content delivery network 100. The depicted embodiment of multimedia content delivery network 100 includes or supports functionality enabling an administrative user such as a parent to control or otherwise manage another user's access to multimedia content. Although multimedia content is not limited to TV, VOD, or pay-per-view programs, the depicted embodiments of multimedia content delivery network 100 and its capabilities are described herein with primary reference to these types of multimedia content, which are interchangeably referred to herein as multimedia content program(s), multimedia programs or, simply, programs.

The elements of multimedia content delivery network 100 illustrated in FIG. 1 emphasize the network's functionality for delivering multimedia content to a set of one or more subscribers. As depicted in FIG. 1, multimedia content delivery network 100 includes one or more clients 120 where each client 120 may represent a different subscriber and a service provider 121 that encompasses resources to acquire, process, and deliver programs to clients 120. Clients 120 and service provider 121 are demarcated by an access network 130 to which clients 120 and service provider 121 are connected. In some embodiments, access network 130 is an Internet protocol (IP) network, while in others, access network 130 may be implemented with alternative network technology. In IP implementations of access network 130, access network 130 may employ a physical layer of unshielded twist pair cables, fiber optic cables, or both. Multimedia content delivery network 100 may employ digital subscribe line (DSL) compliant twisted pair connections between clients 120 and a node (not depicted) in access network 130 while fiber cable or another broadband medium connects service provider resources to a node in access network 130. In other embodiments, the broadband cable may extend all the way to clients 120.

The clients 120 depicted in FIG. 1 include a network appliance identified as customer premises equipment (CPE) 122 that connects to access network 130 and to a multimedia handling device (MHD) 124. CPE 122 may supply routing, firewall, or other services for clients 120. CPE 122 may include elements of a broadband modem such as an asynchronous DSL (ASDL) modem as well as elements of a local area network (LAN) access point that supports a LAN 123 to which MHD 124 connects. LAN 123 may, in some embodiments, represent an Ethernet compliant LAN, also sometimes referred to as an IEEE 811 LAN. Clients 120 as depicted in FIG. 1 further include a display device or, more simply, a display 126. A remote control 128 of client 120 is operable to communicate requests or commands wirelessly to MHD 124 using infrared or radio frequency signals as is well known. MHDs 124 may also receive input via buttons (not depicted) located on side panels of MHDs 124.

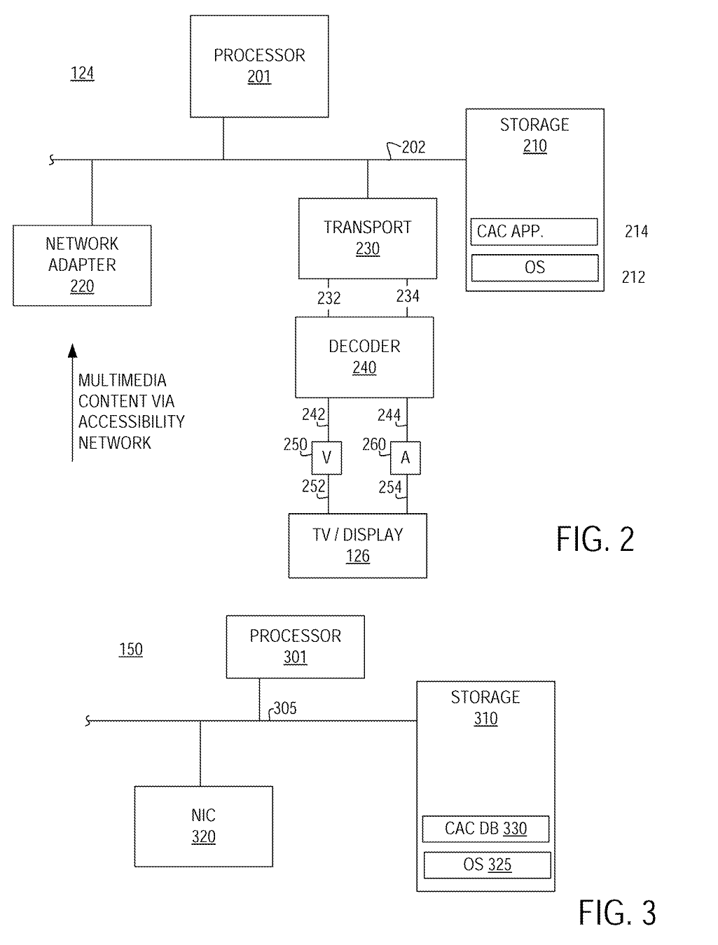

MHD 124 may be implemented as a stand-alone set top box suitable for use in a co-axial or IP-based multimedia content delivery network. In other embodiments, MHD 124 may be integrated with display 126, CPE 122, or both. Referring to FIG. 2, a block diagram illustrating selected elements of MHD 124 is presented. In the depicted embodiment, MHD 124 includes a processor 201 coupled via a shared bus 202 to storage media collectively identified as storage 210. Storage 210 encompasses persistent and volatile media, fixed and removable media, and magnetic and semiconductor media. Storage 210 is operable to store instructions, data, or both. Storage 210 as shown includes two sets or sequences of instructions, namely, an operating system 212 and an application program identified as CAC application 214. Operating system 212 may be a Unix or Unix-like operating system, a Windows® family operating system, or another suitable operating system. CAC application 214 may operate in conjunction with a CAC support database 330 (FIG. 3) that may be implemented, located, or maintained on a networked application server 150 (FIG. 1).

Referring briefly to FIG. 3, selected elements of an embodiment of application server 150 are illustrated. In the depicted embodiment, application server 150 includes a processor 301, storage media identified as storage 310, and a network interface adapter 320. In the depicted embodiment, processor 301 and network interface adapter 320 connect to a shared bus 305 that provides access to storage 310. Storage 310 encompasses persistent and volatile media, fixed and removable media, and magnetic, optical, and semiconductor media. Storage 310 may include processor executable instructions. The instructions embedded or otherwise stored in storage 310 may include an operating system 325 such as a Unix-based or Unix-like operating system or a Windows® based operating system. In addition, storage 310 as depicted in FIG. 3 includes a database structure identified as CAC DB 330. CAC DB 330 may include data to support the operation of CAC application 214 (FIG. 2). Although CAC application 214 is depicted as being located in storage 210 (FIG. 2) of MHD 124 (FIG. 2) and CAC DB 330 is depicted as being located on a networked application server 150 all or portions of CAC application 214 or CAC DB 330 may be downloaded and executed on another network resource including content delivery server 160 (FIG. 1), switch 140, CPE 122, or elsewhere.

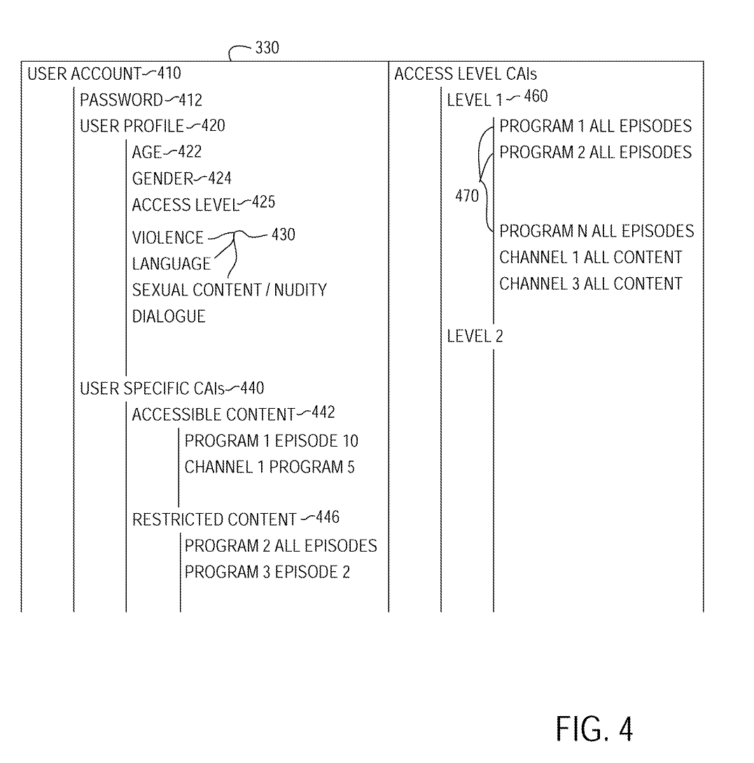

Referring to FIG. 4, an exemplary embodiment of a CAC DB 330 is depicted. In the depicted embodiment, CAC DB 330 includes data corresponding to one or more user accounts 410, only one of which is depicted. User account 410, as suggested by its name, contains content accessibility data pertaining to a subordinate user, although CAC DB 330 may include user accounts for administrators as well. The depicted embodiment of user account 410 includes a password 412, which is defined or controlled by an administrator, and a user profile 420.

The user profile 420 includes information regarding the applicable user and, more beneficially, information about the user that might be relevant to determining multimedia content accessibility controls. In the depicted embodiment, for example, user profile 420 includes information indicative of the user's age (422) and gender (424). In some embodiments, profile 420 may also include additional information referred to herein as susceptibility indicators 430. Susceptibility indicators 430 may include indicators of substantive content that the applicable user should be restricted from viewing. To restrict a user from scenes of violence, for example, a violence indicator may be set in susceptibility indicators 430. Additional susceptibility indicators 430 as shown in FIG. 4 include a language/profanity indicator, a sexual content/nudity indicator, and a dialogue indicator. Susceptibility indicators 430 may track or coincide with ratings that are applied to television and/or movie content. For example, if the violence indicator is set within a particular profile 420, the applicable user may not be able to access television programs that are rated for having violent scenes.

In some embodiments, CAC application 214 uses the profile 420 information to determine an access level 425 from a group of two or more possible access levels. The use of an access level 425 may facilitate the generation of a standard set or initial set of content accessibility indicators. In embodiments that employ access levels 425, a user may be assigned to a particular access level 425 based on age, gender, or other factors.

In some embodiments, a CAC application 214 uses the access level 425, possibly in conjunction with the susceptibility ratings, to define an initial set of CAIs for a group of one or more users. In FIG. 4, an initial set or predetermined set of CAIs are shown for an access level indicated as level 1 (460). Additional access levels may also be determined and used as needed. In the embodiment depicted in FIG. 4, for example, level 1 access CAIs 460 includes a set of CAIs that provide the initial set of CAIs for an applicable user, i.e., a user having access level 1. The initial access level CAIs 470 are defined, in the depicted embodiment, in terms of content that the user is restricted from seeing. In this embodiment, the level 1 access indicators 470 specify that users having level 1 access are restricted from viewing any episodes of a series or program entitled Program 1, Program 2, and Program N. Similarly, level 1 access indicators 470 specify that level 1 user are prohibited from viewing any content on Channel 1 or Channel 3.

In addition to the access level 1 access 460 CAIs that facilitate the generation of an initial set of CAIs, CAC application 214 and CAC DB 330 as depicted in FIG. 4 facilitate the generation of customized or individualized CAIs, an example of which is represented by reference numeral 440. User specific CAIs 440 provide additional sets of CAIs that enable an administrator to vary a user's CAIs from the standard set of level 1 access 460 CAIs.

Administrators may employ user specific CAIs 440 including, in the depicted implementation, an accessible content block 442 that defines content that is accessible to the applicable user and a restricted content block 446 that defines restricted content. In some embodiments, for example, the CAIs in accessible content block 442 define exceptions to the restrictions listed in the level 1 access 460 CAIs. Conversely, the CAIs in restricted content block 446 define additions to the level 1 access 460 CAIs.

CAC application 214 facilitates the generation of values for user specific CAIs 440 as described in greater detail below. The embodiment of CAC DB 330 depicted in FIG. 4 is just one exemplary implementation. Using level 1 access 460 CAIs to define an initial set of CAIs for a user and supplementing or customizing the initial set of CAIs using user specific CAIs, the disclosed implementation facilitates end user control over the content accessible to individual users.

Returning now to FIG. 2, MHD 124 further includes a network adapter 220 that interfaces MHD 124 to LAN 123 and through which MHD 124 receives multimedia content. In embodiments suitable for use in IP-based content delivery networks, MHD 124, as depicted in FIG. 2, may include a transport unit 230 that assembles the payloads from a sequence or set of network packets into a stream of multimedia content. In coaxial based access networks, content may be delivered as a stream that is not packet based and it may not be necessary in these embodiments to include a transport unit 230. In a co-axial implementation, however, clients 120 may require tuning resources (not explicitly depicted in FIG. 1) to “parse” desired content from other content that is delivered over the coaxial medium simultaneously and these tuners may be provided in MHDs 124. The stream of multimedia content received by transport unit 230 may include audio information and video information and transport unit 230 may parse or segregate the two to generate a video stream 232 and an audio stream 234 as shown.

Video stream 232 and audio stream 234, as output from transport unit 230, may include audio or video information that is compressed, encrypted, or both. A decoder unit 240 is shown as receiving video stream 232 and audio stream 234 and generating native format video stream 242 and native format audio streams 244. Decoder 240 may employ any of various widely distributed video decoding algorithms including any of the Motion Pictures Expert Group (MPEG) standards, Windows Media Video (WMV) standards including WMV 9, which has been standardized as Video Codec-1 (VC-1) by the Society of Motion Picture and Television Engineers. Similarly decoder 240 may employ any of various audio decoding algorithms including Dolby® Digital, Digital Theatre System (DTS) Coherent Acoustics, and Windows Media Audio (WMA).

The native format video and audio streams 242 and 244 as shown in FIG. 2 may be processed by encoders/digital-to-analog converters (encoders/DACs) 250 and 260 respectively to produce analog video and audio signals 252 and 254 in a format compliant with display 126. Display 126 may comply with a National Television Systems Committee (NTSC), Phase Alternating Line (PAL), or any other suitable television standard.

Returning now to FIG. 1, the elements of service provider 121 as shown include content acquisition resources 180 connected to a switch 140 via a backbone network 170. An application server 150 and a content delivery server 160 are also shown connected to switch 140. Switch 140 may provide firewall and routing functions to demarcate access network 130 from the resources of service provider 121. Switch 140 may be housed in a central office or other facility of service provider 121. In embodiments that employ DSL compliant connections, switch 140 may include elements of a DSL Access Multiplexer (DSLAM) that multiplexes many subscriber DSLs to backbone network 170. Backbone network 170 represents a private network, preferably a fiber based network, to accommodate tremendous data transfer rates. Content acquisition resources 180 as depicted in FIG. 1 encompasses the acquisition of various types of content including broadcast content, other “live” content including national content feeds, and VOD content.

Acquired content is provided to a content delivery server 160 via backbone network 170 and switch 140. Content may be delivered from content delivery server 160 to clients 120 via access network 130 and switch 140. Content may be compressed, encrypted, modulated, demodulated, and otherwise encoded or processed at content acquisition resources 180, content delivery server 160, or both. Although FIG. 1 depicts a single element encompassing acquisition of all content, different types of content may be acquired via different types of acquisition resources. Similarly, although FIG. 1 depicts a single content delivery server 160, different types of content may be delivered by different servers. Moreover, embodiments of multimedia content delivery network 100 may include content acquisition resources in regional offices that are connected to switch 140.

FIG. 1 further illustrates an application server 150 connected to switch 140. As suggested by its name, application server 150 may host or otherwise implement one or more applications for multimedia content delivery network 100. Applications provided by application server 150 may be downloaded and hosted on other network resources including, for example, content delivery server 160, switch 140, and CPE 122.

Although the service provider 121 is depicted in FIG. 1 as having a single switch 140 to which content acquisition, content delivery, and application servers are connected, other embodiments may employ different switches for each of these functional components and may include additional functional components not depicted in FIG. 1 including, for example, operational subsystem support (OSS) resources. Content delivery server 160 may support unicasting and multicasting. Unicasting consumes more bandwidth per subscriber than multicasting, but unicasting enables a service provider to offer low latency or no latency content delivery to a wide number of clients 120.

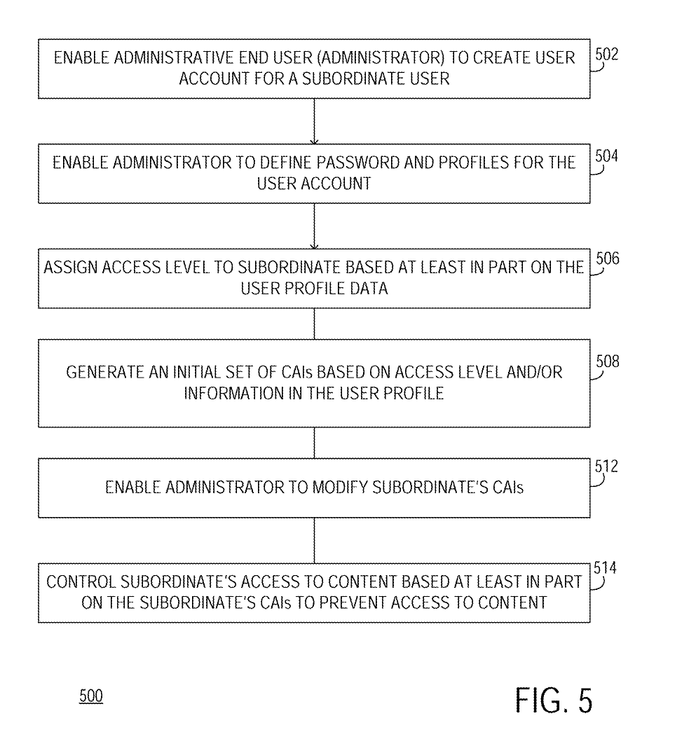

Referring now to FIG. 5, selected elements of an embodiment of a CAC service 500 are depicted. CAC service 500 may be offered by a service provider to its subscriber base for free or on a paid basis. CAC service 500 enables an administrative end user to control subordinate end users' access to content offered by the service provider. In the depicted embodiment, CAC service 500 includes enabling (block 502) an administrative end user such as a parent or other supervisory figure to create a user account for a child or other type of subordinate end user for a multimedia handling device and to create (block 504) a password and a user profile for the subordinate's user account. The subordinate's user profile may include data indicative of one or more characteristics of the subordinate. The service as depicted in FIG. 5 further includes assigning (block 506) an access level to the subordinate based, at least in part, on the subordinate's profile and/or access level. The profile data may include age, gender, and other information pertinent to the type of content that may be suitable or unsuitable for the child. For example, the user profile may include information or data indicating various categories or sub-categories to which the user may be susceptible.

As depicted in FIG. 5, service 500 may generate (block 508) an initial set of CAIs based on the access level. A CAI determines, at least in part, the user's ability to access content associated with the indicator. The initial set of indicators may be predetermined based on a characteristic of the user and may be retrieved or downloaded from a local or remote CAC database such as the database 330 depicted in FIG. 3. Continuing with service 500, the depicted embodiment supports the administrator modifying (block 512) at least one of the CAIs. When a child or other subordinate user subsequently logs into the multimedia handling device, the application may then process (block 514) requests or commands for content including navigation signal commands based at least in part on the CAIs to prevent the user from accessing content restricted responsive to a navigation signal issued when the user account is active.

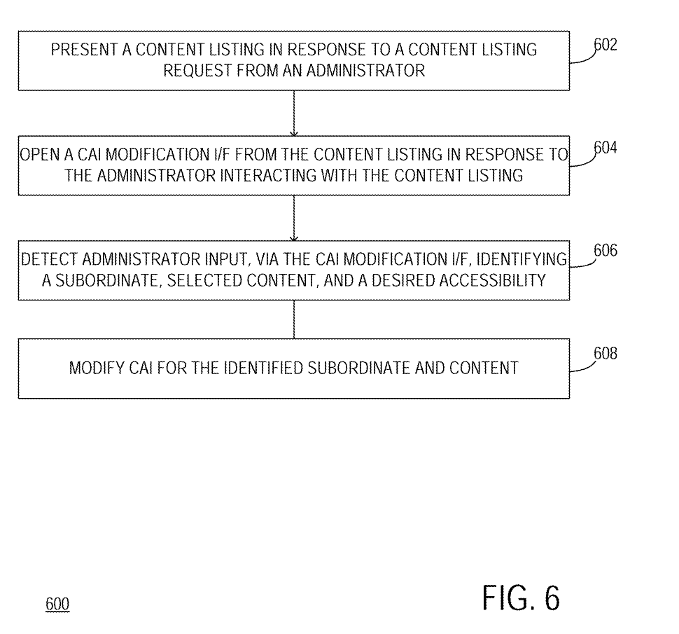

Turning now to FIG. 6, the depicted flow diagram illustrates selected elements of an embodiment of a method 600, supported by a CAC application 214, by which an administrator modifies the CAIs of a subordinate end user. The depicted embodiment of method 600 emphasizes functionality of CAC application 214 that enables an administrator to modify CAI from various interfaces that a multimedia content device, system, or network might present to the administrator. Although the depicted embodiment of method 600 is described in the context of a TV/VOD based multimedia distribution network, the concepts underlying the described implementation are applicable in other contexts as well.

Method 600 as depicted in FIG. 6 includes presenting (block 602) a content listing in response to a content listing request from an administrator. Content listings encompass any displayed table or listing of at least some available content. A content listing includes, for example, an EPG or other interface that indicates currently available “live” television content. Another example of a content listing is a VOD interface that indicates one or more movies or other video content that is available on an on demand basis. A DVR listing is still another example of a content listing. A DVR listing is applicable for subscribers to DVR functionality. DVR subscribers are able to record live content onto local and/or networked storage media and later play back the recorded content on an on-demand basis. DVR service typically includes functionality enabling the subscriber or other use to stop, rewind, fast forward, and otherwise control the playback of content.

As depicted in FIG. 6, a content listing is displayed or otherwise presented to an administrator in response to a content listing request from the administrator. In some embodiments, this content listing request encompasses any signal, command, or instruction initiated by the administrator that causes a set top box or other type of MHD to display the requested listing. A listing request might, for example, correspond to an administrator pressing, clicking, or otherwise asserting a button on a remote control device. In another embodiment, the content listing requested might include an administrator selecting an object from a menu or other graphical interface, typing in a text based request, or any other suitable form of requesting content.

The depicted embodiment of method 600 further includes opening (block 604) a CAI modification interface in response to the administrator interacting with the content listing. According to this embodiment, the administrator enjoys the ability to access and modify CAIs directly from any of the various content listings that a platform might support. Thus, for example, an administrator might interact with an EPG display to alter the CAIs for one or more users. The modification interface presented to the administrator might be implemented as a graphical interface including selectable objects to facilitate access to and modification of CAIs. The depicted embodiment of method 600 includes detecting (block 606), via the CAI modification interface, administrator input that identifies one or more subordinate users, the applicable content, and a desired accessibility, i.e., a desired value for the applicable CAI or CAIs. The selection of the applicable subordinates might be achieved using a drop down menu listing all of the subordinate users for whom user accounts have been established. Selection of the applicable content may require little or no additional input from the administrator. For example, the EPG or other listing may be presented in the form of a grid or array indicating a time of day and a channel for available content. As the administrator navigates the listing, a content item may be highlighted within the display. When the administrator invokes a CAI modification interface, the CAI modification interface may identify the content item that was highlighted when the CAI modification interface was invoked as the content item to which the CAI modification pertains. The CAI modification interface enables the administrator to specify the accessibility of the applicable content for the applicable subordinate(s). When the administrator has specified the subordinate(s), the content, and the accessibility value, the CAI modification interface then modifies (block 608) the CAI or CAIs of the applicable subordinates.

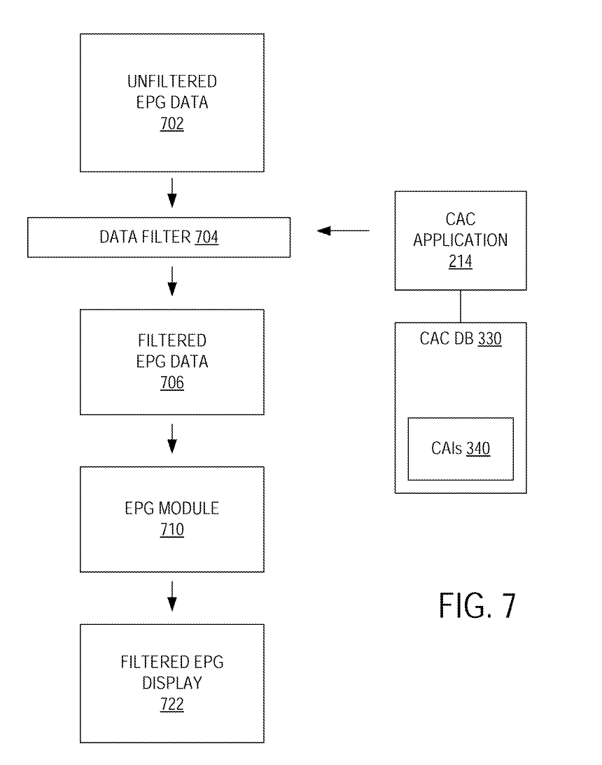

FIG. 7 is a pictorial representation of selected functionality provided by at least some embodiments of a CAC application 214. As emphasized by FIG. 7, the content accessibility control provided by CAC application 214 extends beyond a subordinate's ability to access the content itself and encompasses the listings of content and the associated interfaces that are presented to a subordinate. FIG. 7 illustrates this concept in the context of an EPG display. As depicted in FIG. 7, CAC application 214 interacts with an EPG module 710 to produce an EPG display, referred to in FIG. 7 as filtered EPG display 720, when a subordinate user invokes an EPG. Filtered EPG display 720, as suggested by its name, lists only that content defined as accessible to the subordinate user in the subordinate user's CAC DB 330.

As depicted in FIG. 7, CAC application 214 filters “raw” or unfiltered EPG data, represented by reference numeral 702. Unfiltered EPG data 702 may reside in storage that is local to the subscriber or end user, i.e., the administrator(s) and/or the subordinate user(s). For example, unfiltered EPG data 702 may reside in storage on the subscriber's set top box. The unfiltered EPG data 702 includes data about the available multimedia content. Because the EPG data 702 represents “data about data,” EPG data 702 is sometimes referred to as being or including metadata. The metadata may indicate various characteristics of the content including, for example, series or program title, episode title, channel, TV rating or MPAA rating for movies, the names of at least some of the leading actors, an abstract or brief summary of the plot, and so forth.

In the depicted implementation, CAC application 214 applies a data filter 704 derived from subordinate user information in CAC database 330 and CAIs 340 to unfiltered EPG data 702 to generate or identify filtered EPG data 706, which represents that portion of content listed in unfiltered EPG data 702 to which the subordinate user has access privileges. An EPG module 710 then acts on the filtered EPG data 706 to generate a filtered EPG display 720. Because the filtered EPG display 720 is derived from filtered EPG data 710, filtered EPG display 720 does not display an EPG listing for content that is restricted from the user.

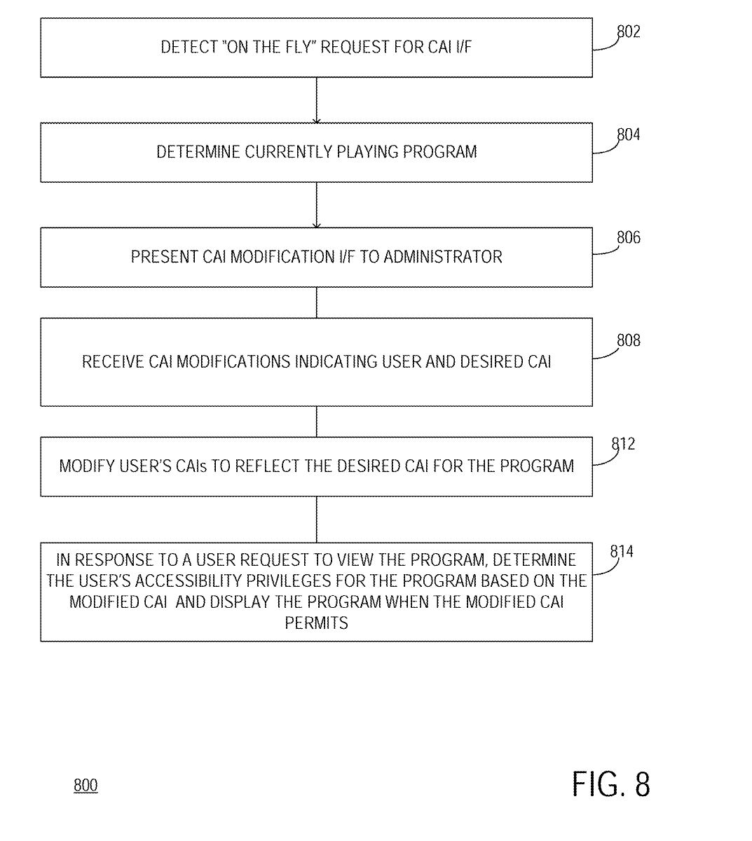

Turning now to FIG. 8, a flow diagram is depicted of selected elements of an embodiment of a method 800 enabling an administrator to modify a CAI “on the fly.” Method 800 may be performed or administered by a CAC application. In the depicted embodiment, method 800 includes detecting (block 802) an “on-the-fly” request for a CAI interface. In this context, the term “on-the-fly” refers to an administrator's request to modify a CAI for a program while the administrator is viewing the program. This on-the-fly functionality enables administrators to quickly and easily modify CAIs and otherwise control access. The on-the-fly request might be issued by an administrator clicking, pushing, or otherwise asserting a remote control button to invoke a CAI modification interface.

In response to detecting an on-the-fly request for a CAC interface, method 800 as shown includes determining (block 804) information regarding the content or program that is currently playing. The on-the-fly CAI modification request generally pertains to the content that the administrator is currently viewing.

After identifying the currently playing program, the depicted embodiment of method 800 includes presenting (block 806) a CAI modification interface to the administrator. The administrator may then modify or otherwise transmit CAI modifications and the CAC application would receive (block 808) those modifications. As depicted in FIG. 8, the CAI modifications received by the CAC application in block 808 indicate the user or class of users whose CAIs are being modified and the modified value.

CAC application 214 might then modify (block 812) the CAIs of the applicable user(s) to reflect the desired CAI for the program. Thereafter, CAC application 214 might determine (block 814) a user's access privileges for a program based on the modified CAI. CAC application 214 might, in some embodiments, display or restrict the program based on the modified value of the CAI.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A content accessibility control service, comprising:
enabling an administrator to create a user account having a password and a profile;
assigning an access level to a user associated with the user account;
generating an initial set of content access indicators (CAIs) based on the access level, wherein a CAI determines, at least in part, the user's ability to access content associated with the indicator;
responsive to a request from the administrator, modifying at least one of the CAIs; and
responsive to a navigation signal issued when the user account is active, processing the navigation signal based at least in part on the CAIs to prevent the user from accessing restricted content.

2. The service of claim 1, wherein the user profile is indicative of an age of the user.

3. The service of claim 2, wherein the user profile is indicative of at least one content category or sub-category.

4. The service of claim 1, wherein modifying includes presenting a CAI modification interface to the administrator.

5. The service of claim 4, wherein presenting the CAI modification interface comprises invoking the CAI modification interface from an electronic programming guide interface.

6. The service of claim 4, wherein presenting the CAI modification interface comprises launching the access CAI from a digital video record interface.

7. The service of claim 4, wherein presenting the CAI modification interface comprises invoking the CAI modification interface from a video on demand interface.

8. The service of claim 4, wherein presenting the CAI modification interface comprises invoking the CAI modification interface in response to a remote control or set top box input while the administrator is viewing content.

9. The service of claim 1, wherein the content associated with the CAI is a single episode of a program.

10. The service of claim 1, wherein the content associated with the content accessibility is multiple episodes of a program.

11. The service of claim 1, wherein the content associated with the CAI includes all programs associated with a selected channel.

12. A computer program product comprising instructions, stored on computer readable media, for managing access to multimedia content, the instructions comprising instructions to:
create a user account in response to a request from an administrator;
associate a user profile with the user account, wherein the user profile is indicative of a characteristic of a user;
associate content access indicators (CAIs) with the user based, at least in part, on the user profile;
permit access to a content item based on the CAIs when the user account is active; and
modify the user's CAIs in response to a signal from the administrator when an administrator account is active.

13. The computer program product of claim 12, wherein at least one of the CAIs corresponds to an episode of a program.

14. The computer program product of claim 12, wherein at least one of the CAIs corresponds to multiple episodes of a program.

15. The computer program product of claim 12, wherein at least one of the CAIs corresponds to content provided via a specific channel.

16. The computer program product of claim 12, wherein associating the CAIs comprises assigning an access level to the user account based on the user profile and determining the CAIs based on the access level.

17. The computer program product of claim 16, further comprising instructions to respond to a user request to list content by presenting a content listing interface listing only that content to which the user has access.

18. The computer program product of claim 17, wherein presenting the content listing interface includes presenting a video on demand interface.

19. The computer program product of claim 17, wherein presenting the content listing interface includes presenting an electronic programming guide interface.

20. The computer program product of claim 17, wherein presenting the content listing interface includes presenting a digital video recorder interface.

21. A multimedia handling device, comprising:
a processor;
a multimedia resource operable to produce multimedia output suitable for visual or audible consumption by a viewer;
storage accessible to the processor and computer executable instructions, embedded in the storage, wherein the instructions include instructions to:
present a program of multimedia content to an administrator when an administrator account is active;
respond to a modify content access indicator (CAI) signal when the administrator account is active by presenting a CAI interface to the administrator;
respond to input to the CAI interface by modifying a CAI; and
determining whether to present content to the user based on the CAIs.
